(19) United States
(12) Patent Application Publication
(10) Pub. No.: US 2023/0176558 A1
(43) Pub. Date: Jun. 8, 2023

(54) SYSTEM AND METHOD FOR AUTOMATIC CONDITION MONITORING OF MOBILITY SYSTEMS

(71) Applicant: University of Pittsburgh-Of the Commonwealth System of Higher Education, Pittsburgh, PA (US)

(72) Inventors: Anand Ashok Mhatre, Columbus, OH (US); Jonathan L. Pearlman, Pittsburgh, PA (US)

(73) Assignee: University of Pittsburgh-Of the Commonwealth System of Higher Education, Pittsburgh, PA (US)

(21) Appl. No.: 17/933,616

(22) Filed: Sep. 20, 2022

Related U.S. Application Data
(60) Provisional application No. 63/264,794, filed on Dec. 2, 2021.

(51) Int. Cl. G05B 23/02; A61G 5/10

(52) U.S. Cl. CPC G05B 23/0243; G05B 23/027; A61G 5/10; A61G 2203/36; A61G 2203/46

(57) ABSTRACT

A system for monitoring a condition of a mobility system includes a number of sensors coupled to the mobility system, the number of sensors being structured and configured to generate data indicative of use of the mobility system during use, and a controller implementing a trained machine learning system. The controller is structured and configured to receive the data, characterize a lifecycle stage of the mobility system using the trained machine learning system based on at least the received data, and generate an alert for required maintenance for and/or predicted breakdown of the mobility system based on the characterized lifecycle stage.

### CROSS-REFERENCE TO RELATED APPLICATIONS

This application claims priority under 35 U.S.C. § 119(e) from U.S. provisional patent application No. 63/264,794, entitled “System and Method for Automatic Condition Monitoring of Mobility Systems” and filed on Dec. 2, 2021, the contents of which are incorporated herein by reference.

### STATEMENT OF GOVERNMENT INTEREST

This invention was made with government support under grant #s AG069836 and TR001857 awarded by the National Institutes of Health (NIH) and grant #1734751 awarded by the National Science Foundation (NSF). The government has certain rights in the invention.

### FIELD OF THE INVENTION

The disclosed concept relates generally to mobility systems, and, in particular, to an automated system and method for monitoring the condition of a mobility system, including predicting failure and maintenance needs, that is coupled to the mobility system and that includes a controller and an array of sensors for such automated condition monitoring.

### BACKGROUND OF THE INVENTION

Users of mobility system, such as wheelchairs, often suffer due to the failure and/or breakdown of such mobility systems. In fact, around one-third of such users are at high risk for suffering an injury following the failure and/or breakdown of their mobility system. Such failures can be averted through the implementation of maintenance and inspection practices and strategies for such systems that measure and monitor how often and in what the conditions the mobility system is being used. Currently, however, there are no tools for automatically predicting mobility system failures and maintenance needs.

### SUMMARY OF THE INVENTION

In one embodiment, a system for monitoring the condition of a mobility system as provided. The system includes a number of sensors coupled to the mobility system, the number of sensors being structured and configured to generate data indicative of use of the mobility system during use, and a controller implementing a trained machine learning system. The controller is structured and configured to receive the data, characterize a lifecycle stage of the mobility system using the trained machine learning system based on at least the received data, and generate an alert for required maintenance for and/or predicted breakdown of the mobility system based on the characterized lifecycle stage.

In another embodiment, a method of monitoring the condition of a mobility system is provided. The method includes generating data indicative of use of the mobility system using a number of sensors, receiving the data in a trained machine learning system, characterizing a lifecycle stage of the mobility system using the trained machine learning system based on at least the received data, and generating an alert for required maintenance for and/or predicted breakdown of the mobility system based on the characterized lifecycle stage.

### BRIEF DESCRIPTION OF THE DRAWINGS

FIG. 1 is a schematic diagram of a mobility system according to one particular exemplary embodiment of the disclosed concept;

FIG. 2 is a schematic diagram of a condition monitoring system according to one non-limiting exemplary embodiment of the disclosed concept; and

FIG. 3 is a schematic diagram of a condition monitoring system according to another non-limiting exemplary embodiment of the disclosed concept.

### DETAILED DESCRIPTION OF THE INVENTION

As used herein, the singular form of “a”, “an”, and “the” include plural references unless the context clearly dictates otherwise.

As used herein, the statement that two or more parts or components are “coupled” shall mean that the parts are joined or operate together either directly or indirectly, i.e., through one or more intermediate parts or components, so long as a link occurs.

As used herein, “directly coupled” means that two elements are directly in contact with each other.

As used herein, the term “number” shall mean one or an integer greater than one (i.e., a plurality).

As used herein, the terms “component” and “system” are intended to refer to a computer related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term “mobility system” shall mean a unit that is used for ambulation of an individual, including, for example and without limitation, wheelchairs, rollators, walkers, canes, crutches, strollers, tricycles and prosthetics.

As used herein, the term “controller” shall mean a programmable analog and/or digital device (including an associated memory part or portion) that can store, retrieve, execute and process data (e.g., software routines and/or information used by such routines), including, without limitation, a field programmable gate array (FPGA), a complex programmable logic device (CPLD), a programmable system on a chip (PSOC), an application specific integrated circuit (ASIC), a microprocessor, a microcontroller, a programmable logic controller, or any other suitable processing device or apparatus. The memory portion can be any one or more of a variety of types of internal and/or external storage media such as, without limitation, RAM, ROM, EPROM(s), EEPROM(s), FLASH, and the like that provide a storage register, i.e., a non-transitory machine readable medium, for data and program code storage such as in the fashion of an internal storage area of a computer, and can be volatile memory or nonvolatile memory.

As used herein, the term “time-series regression model” shall mean a class of machine learning system/algorithm that predicts a future response based on the response history and the transfer of dynamics from relevant predictors.

Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

The disclosed concept will now be described, for purposes of explanation, in connection with numerous specific details in order to provide a thorough understanding of the subject invention. It will be evident, however, that the disclosed concept can be practiced without these specific details without departing from the spirit and scope of this innovation.

As described in greater detail herein and in Appendix A attached hereto, the disclosed concept provides a system and method for monitoring the condition of a mobility system, such as a wheelchair, based on measurements that are made during the use of the mobility system by various sensors. In the exemplary embodiment, the sensors include one or more shock and/or vibration sensors and one or more environmental condition sensors, such as, without limitation, humidity and/or temperature sensors, that each provide information that is indicative of the lifecycle stage (e.g., including a degree of usage and/or wear) of the mobility system and that is relevant to predicting breakdown of the mobility system. Specifically, the data from the sensors is provided to a trained machine learning system, which in the exemplary embodiment is a time-series regression model (or, alternatively, another machine learning system such as a deep learning system), that, based on those input values and the model, is able to generate an index that characterizes the degree of degradation of the mobility system based on the predicted wear and tear it has experienced during use. In one particular non-limiting exemplary embodiment described herein, the system includes a combination of a number of accelerometers, a magnetometer, a gyroscope, a humidity sensor and a temperature sensor, each of which is deployed for collecting mobility system usage data. The data collected by such sensors (representing mobility system usage parameters) is provided to the machine learning system, which determines the usage index and generates timely maintenance notifications for the mobility system user based on the received usage parameters. In the exemplary embodiment, such notifications are triggered and sent when the usage index is determined to be over a certain amount, which indicates a level of where that needs attention. Also in the exemplary embodiment, such notifications are sent to a user device, such as a smartphone, by way of a wireless connection, such as a Bluetooth connection. In another exemplary embodiment, a cloud-based registry is hosted for all users of the disclosed concept. In such an embodiment, the notification or alert data is transmitted to the cloud-based registry, which in turn will send a notification, such as an email or other electronic notification, to one or more third parties, such as a caregiver or equipment supplier. Also, an on-demand technical support service could be alerted.

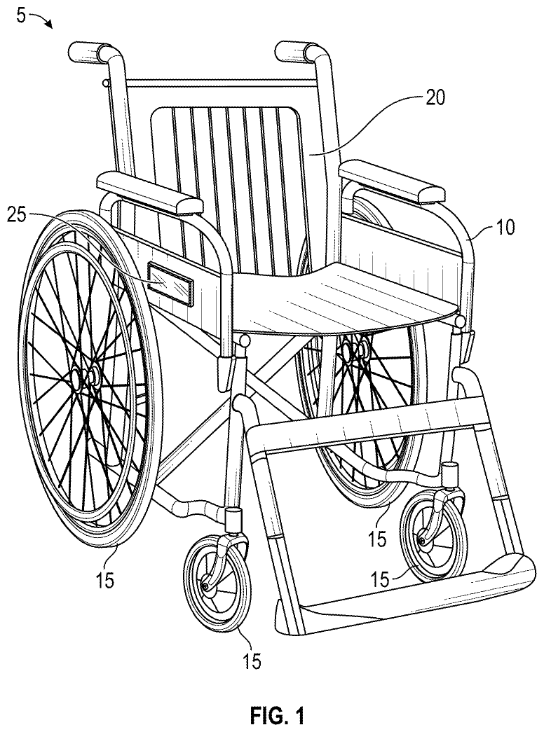

FIG. 1 is a schematic diagram of a mobility system 5 according to one particular exemplary embodiment of the disclosed concept. As seen in FIG. 1, mobility system 5 is a wheelchair, although it will be understood that this is meant to be exemplary only and that other specific types of mobility systems are contemplated within the scope of the disclosed concept. Mobility system 5 includes a frame 10, a plurality of wheels 15 coupled to the frame 10, and a seat member 20 coupled to and supported by the frame 10. Mobility system 5 further includes a condition monitoring system 25 according to one or more embodiments of the disclosed concept which is mounted to mobility system 5 Condition monitoring system 25 may be mounted at different places for different mobility systems. For example, on the chassis for a power wheelchair, on the axle for and ultralight wheelchair and on the frame for a standard wheelchair and stroller/tilt-in-space chairs. As described in detail herein, condition monitoring system 25 is structured and configured to collect data relating to usage of mobility system 5 using various sensors and provide that data to a trained machine learning system forming a part of condition monitoring system 25. Condition monitoring system 25 will then, based on those input values and the model, generate an index that characterizes the lifecycle stage (e.g., including a degree of use or wear related degradation of mobility system 5). As noted elsewhere herein, the generated index may then be used to provide various alerts and/or notifications to the user and/or third parties so that maintenance steps can be taken to prevent predicted failure conditions.

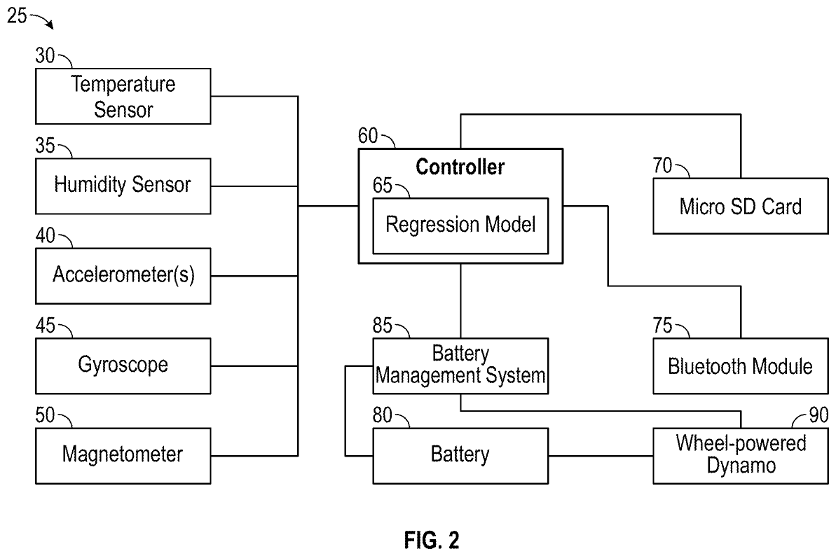

FIG. 2 is a schematic diagram of condition monitoring system 25 according to one non-limiting exemplary embodiment of the disclosed concept. As seen in FIG. 2, condition monitoring system 25 includes a plurality of motion-related and environmental condition-related sensors. In the non-limiting illustrated embodiment, such sensors include a temperature sensor 30 for measuring the ambient temperature around mobility system 5, a humidity sensor 35 for measuring the relative humidity around mobility system 5, one or more accelerometers 40 for measuring impacts, shocks and/or vibrations experienced by mobility system 5, a gyroscope 45 for measuring parameters relating to ground slope and for measuring force generated by mobility system 5 when hitting an obstacle while moving, and a magnetometer 50 that tracks the motion of an included magnet that moves in a rotational or translational manner. It will be understood, however, that the particular configuration shown in FIG. 2, including the particular sensors that are shown therein, is meant to be exemplary in nature and that a subset of one or more of the sensors that are shown, or even additional sensors, may be employed in connection with the disclosed concept. For example, additional sensors may include location, pressure and force sensors and/or digital shock detectors.

As seen in FIG. 2, each of the sensors just described is coupled in a manner such that the outputs thereof are provided to a controller 60 forming a part of condition monitoring system 25. Controller 60 includes a time-series regression model 65 that has been previously trained as described herein to predict wear and failure conditions based on the sensor inputs. Time-series regression model 65 is implemented in controller 60 in the form of one or more routines executable by the processing portion of controller 60. In addition, while controller 60 in the present illustrated embodiment includes a machine learning algorithm in the form of time-series regression model 65, it will be appreciated that other types of machine learning algorithms may also be employed within the scope of the disclosed concept.

Condition monitoring system 25 further includes a storage device for storing data that is provided to controller 60 from the various sensors. In the illustrated embodiment, the storage device is a micro SD card 70. In particular, it is contemplated that the sensor data will be stored directly in the RAM of controller 60 and, whenever the buffer storage goes beyond a threshold, controller 60 will log the data into micro SD card 70 for use thereafter as needed. The SD card implementation shown in the illustrated embodiment is helpful for research as that entails currently training the model and collecting data at high frequency. During implementation, it may be best to omit such an SD card because it is uses a significant amount of power for logging data. Instead, data may be kept on RAM (e.g., >8 MB FLASH memory) and the app may be used to notify users for connecting via Bluetooth every week or bimonthly for transferring filtered data.

In addition, condition monitoring system 25 includes a Bluetooth module 75 for enabling condition monitoring system 25 to communicate information wirelessly to one or more devices, such as, without limitation, a smartphone or other computing device of a user.

Condition monitoring system 25 also includes a rechargeable battery 80 coupled to a battery management system 85 for providing power to the components of condition monitoring system 25. In the case of powered mobility systems, power may be supplied by the system's battery. In addition, in the illustrated embodiment, condition monitoring system also includes a wheel-powered dynamo 90 that is coupled to one or more of wheels 15 of mobility system 5. Wheel-powered dynamo 90 is structured to convert the rotational energy of one or more wheels 15 into electrical energy for charging battery 80 and/or providing power to the components of condition monitoring system 25 through battery management system 85.

In operation, the various sensors shown in FIG. 2 will collect data during the use of mobility system 25. That data is provided to controller 60 and, if necessary, to micro SD card 70. Periodically, such as once a day or once a week, controller 65 will provide that data to regression model 65. In response, the trained time-series regression model 65 will analyze the data and based thereon calculate the usage/wear index as described herein, which is indicative of the extent of wear that is being experienced by mobility system 25 (and therefore the likelihood of a failure). In the event that the usage/wear index exceeds a certain preset threshold level, controller 60 will cause Bluetooth module 75 to send an alert/notification to a device of the user, such as a smartphone, which indicates that certain maintenance and/or failure prevention steps must be taken in the near term in order to minimize the likelihood of a failure. As described elsewhere herein, that information may also be communicated to third parties such as caregivers or equipment suppliers using any suitable method, such as having the user device transmit same to those entities.

Thus, condition monitoring system 25 provides an automated system and method for monitoring the condition of mobility system 5 which characterizes the degree of degradation of mobility system 5 based on the predicted wear and tear it has experienced during use so that corrective action may be taken in advance. For example, when the usage/wear index approaches or exceeds the threshold that indicates the likelihood of a critical failure of mobility system 5, such as, for example, due to the fracture of a caster or rear wheel, the condition monitoring system 25 alerts for mobility system maintenance.

In the exemplary embodiment, the training of time-series regression model 65 is performed in two stages. In the first stage, the base model is built by testing mobility system 5 on a standard mechanical test bed simulating outdoor conditions and collecting shock data until failure (e.g., using one or more of accelerometer(s) 40, gyroscope 45, and magnetometer 50. In the exemplary embodiment, humidity and temperature data are also collected during testing and will be part of the initial training. Once the prominent failure mode has been established in this first stage, the base model is then trained using road shock data (e.g., using one or more of accelerometer(s) 40, gyroscope 45, and magnetometer 50) and environmental data (e.g., using temperature sensors 30 and/or humidity sensor 35) collected with a number of (e.g. 30 or more) users of mobility system 5 until the same failure occurs. The usage/wear index is specifically the damage sustained by mobility system 5, which, in the exemplary embodiment of the disclosed concept, is computed using any suitable damage prediction model, such as one or more variations of Miner's rule (i.e. if shock amplitude is plotted versus number of shocks, the damage is the area under the curve). As noted herein, it is anticipated that the additional environmental variables of humidity and temperature will be included with shock in making the determination of the usage/wear index.

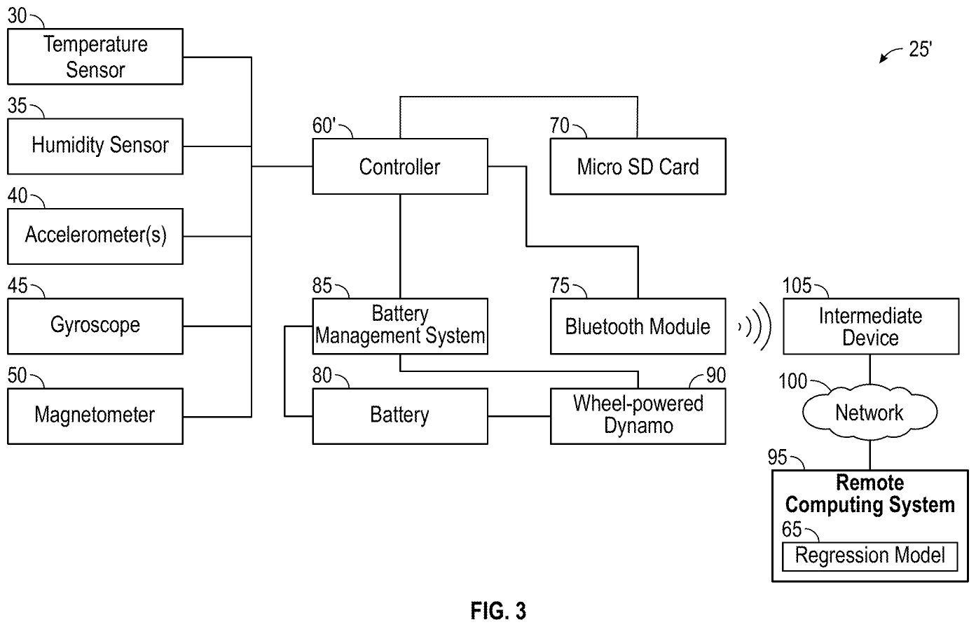

In the embodiments just described in connection with FIG. 2, time-series regression model 65 is resident on controller 60 of condition monitoring system 25. In an alternative embodiment, shown in FIG. 3, time-series regression model 65 is instead resident on a cloud-based remote computing system 95, which is structured to determine the usage/wear index as described herein (based on data collected by modified condition monitoring system 25′ that is mounted on mobility system 5; like parts being labelled with like reference numerals) and provide alerts as described herein to the appropriate recipients, such as the user of mobility system 5, a caregiver, or any equipment supplier. In this embodiment, the communication of the collected data from modified condition monitoring system 25′ to remote computing system 95 can be done in any of a number of known manners, including various wired and/or wireless transmission mechanisms, such as Bluetooth and WiFi. For example, Bluetooth module 75 may be used to connect to a wireless router or other intermediate device 105 to enable the transmission of the data of over one or more appropriate networks 100. Alternatively, modified condition monitoring system 25′ may include a long range wireless communication module, such as a broadband module, to enable the communication of such data to remote computing system 95 over a number of suitable networks 100.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof. For example, and without limitation, the system can be part of a smartphone or tablet for data collection. With the smartphone sensor specifications, the system is suitable for institutional environments. Also, users may prefer a green/red LED as an indicator of wheelchair health or a beeping buzzer. These can be alternate ways of communicating to older adults who do not prefer using an app as described herein, and would instead like to be notified of maintenance by these simpler methods.

What is claimed is:

1. A system for monitoring a condition of a mobility system, comprising:
a number of sensors coupled to the mobility system, the number of sensors being structured and configured to generate data indicative of use of the mobility system during use; and
a controller implementing a trained machine learning system, wherein the controller is structured and configured to:
receive the data;
characterize a lifecycle stage of the mobility system using the trained machine learning system based on at least the received data; and
generate an alert for required maintenance for and/or predicted breakdown of the mobility system based on the characterized lifecycle stage.

2. The system according to claim 1, wherein the data is shock and/or vibration data indicative of one or more shocks and/or vibrations experienced by the mobility system during use.

3. The system according to claim 2, wherein the lifecycle stage includes a degree of wear on the mobility system.

4. The system according to claim 1, wherein the number of sensors includes at least one accelerometer.

5. The system according to claim 1, wherein the number of sensors includes a magnetometer.

6. The system according to claim 1, wherein the number of sensors includes a gyroscope.

7. The system according to claim 1, wherein the number of sensors includes at least one accelerometer and at least one of a magnetometer or a gyroscope.

8. The system according to claim 7, wherein the number of sensors includes at least one accelerometer, a magnetometer, and a gyroscope.

9. The system according to claim 3, further comprising a number of environmental conditions sensors coupled to the mobility system, the number of environmental conditions sensors being structured and configured to generate environmental condition data indicative of one or more environmental conditions around the mobility system during use of the mobility system, wherein the trained machine learning system is structured and configured to receive the environmental condition data and characterize the degree of wear based on the received shock and/or vibration data and the environmental condition data.

10. The system according to claim 9, wherein the number of environmental conditions sensors comprises at least one of a temperature sensor and a humidity sensor.

11. The system according to claim 10, wherein the number of environmental condition sensors comprises a temperature sensor and a humidity sensor.

12. The system according to claim 3, wherein the trained machine learning system is structured and configured to characterize the degree of wear by determining a usage index based on at least the received shock and/or vibration data, and wherein the controller is structured and configured to generate the alert when the determined usage index exceeds a certain predetermined threshold value.

13. The system according to claim 12, wherein the usage index is generated using Miner's rule.

14. The system according to claim 1, wherein the controller is part of the mobility system.

15. The system according to claim 1, wherein the controller is part of a remote computing system in electrical communication with the mobility system.

16. The system according to claim 1, wherein the trained machine learning system comprises a regression model.

17. The system according to claim 14, wherein the regression model is a time-series regression model.

18. A method of monitoring a condition of a mobility system, comprising:
generating data indicative of use of the mobility system using a number of sensors;
receiving the data in a trained machine learning system;
characterizing a lifecycle stage of the mobility system using the trained machine learning system based on at least the received data; and
generating an alert for required maintenance for and/or predicted breakdown of the mobility system based on the characterized lifecycle stage.

19. The method according to claim 18, wherein the data is shock and/or vibration data indicative of one or more shocks and/or vibrations experienced by the mobility system during use.

20. The method according to claim 19, wherein the lifecycle stage includes a degree of wear on the mobility system.

21. The method according to claim 18, wherein the number of sensors includes at least one accelerometer.

22. The method according to claim 18, wherein the number of sensors includes a magnetometer.

23. The method according to claim 18, wherein the number of sensors includes a gyroscope.

24. The method according to claim 18, wherein the number of sensors includes at least one accelerometer and at least one of a magnetometer or a gyroscope.

25. The method according to claim 24, wherein the number of sensors includes at least one accelerometer, a magnetometer, and a gyroscope.

26. The method according to claim 18, further comprising generating environmental condition data indicative of one or more environmental conditions around the mobility system during use of the mobility system using a number of environmental conditions sensors coupled to the mobility system, and receiving the environmental condition data in the trained machine learning system, wherein the characterizing comprises characterizing the degree of wear based on the received shock and/or vibration data and the environmental condition data.

27. The method according to claim 26, wherein the number of environmental conditions sensors comprises at least one of a temperature sensor and a humidity sensor.

28. The method according to claim 27, wherein the number of environmental condition sensors comprises a temperature sensor and a humidity sensor.

29. The method according to claim 20, wherein the trained machine learning system is structured and configured to characterize the degree of wear by determining a usage index based on at least the received shock and/or vibration data, and wherein the alert is generated when the determined usage index exceeds a certain predetermined threshold value.

30. The method according to claim 29, wherein the usage index is generated using Miner's rule.

31. The method according to claim 18, wherein the trained machine learning system is provided as part of the mobility system.

32. The method according to claim 18, wherein the trained machine learning system is provided as part of a remote computing system in electrical communication with the mobility system.

33. The method according to claim 18, wherein the trained machine learning system comprises a regression model.

34. The method according to claim 18, wherein the regression model is a time-series regression model.
